(19) United States
(12) Patent Application Publication
(10) Pub. No.: US 2001/0034694 A1
(43) Pub. Date: Oct. 25, 2001

(54) System for providing an online collectibles marketplace

(76) Inventor: Brian K. Elias, Springboro, OH (US)

Correspondence Address: Douglas A. Yerkeson, BIEBEL & FRENCH LPA, 35 East First Street, Dayton, OH, 45402, US

(21) Appl. No.: 09/792,983

(22) Filed: Feb. 26, 2001

Related U.S. Application Data
(60) Provisional application No. 60/185,150, filed on Feb. 25, 2000.

(51) Int. Cl. G06F 17/60

(52) U.S. Cl. 705/37

(57) ABSTRACT

An online system for a collectibles marketplace is provided. The system proffers a collectibles hierarchy consisting of collectibles subject matter. The hierarchy terminates into a plurality of collectible item leaf nodes. The collectible item leaf nodes contain therein a plurality of descriptive collectibles data, including searchable data fields. User entered auction, barter and classified listings are received and associated with each of the respective collectible item leaf nodes. An identification system (eg. alpha-numeric numbering system or other identification system) for uniquely identifying and labeling hierarchical branches, collectible item leaf nodes and related user entered listings is provided. Associated with the collectibles hierarchy, collectible item leaf nodes and listings is an electronic appraisal warehouse, comprised of data related to a plurality of archived sales, barters, and auctions, including associated graphical and media representations, and further related information such as selling price, condition/grade as described, etc., organized and classified according to the hierarchy branches, collectible item leaf nodes, listings and further sortable by selectable data attributes, such as sales price, condition, etc. Detailed, real time market place information pertaining to the various levels of the collectibles hierarchy, including the collectible item leaf nodes, is made available via an online transaction manager and related collectibles database and manager.

This application claims the benefit of U.S. provisional patent application Ser. No. 60/185,150, filed Feb. 25, 2000, the disclosure of which is incorporated herein by reference.

### BACKGROUND OF THE INVENTION

1. Field of the Invention

The present invention relates to computer based online commerce systems and methods as applied to collectibles, used goods, or secondary market goods (hereinafter referred to collectively as “collectibles”). More particularly, the present invention relates to an online database service (hereinafter “market site”), which provides a marketplace for completing online transactions, said market site further providing hierarchically catalogued descriptive information pertaining to the associated collectibles, including information related to the market conditions and sales trends of the collectibles, appraisal information pertinent to the collectibles (including an up-to-date “virtual” price guide), product information relating to the collectibles, the means for signaling particular market events associated with the collectibles, and lastly, the means for identifying and managing collectibles inventory.

2. Description of the Related Art

Online transaction systems, similar in type to that of U.S. Pat. No. 5,835,896 to Fisher et al., and U.S. Pat. No. 6,012,045 to Barzilai, et al., herein incorporated by reference, have recently gained widespread acceptance as new, convenient mechanisms for dealing in goods online. Online internet sites such as Ebay.com, Onsale.com, Ubarter.com, Tradeum.com, Bartertrust.com, Amazon.com and Priceline.com have provided new electronic transaction paradigms which have demonstrated true value in the marketplace. While extremely useful as commerce conduits, these sites generally do not provide useful real time marketplace information, appraisal information, and assimilated category/item information.

Currently, online listings maintained on collectibles commerce sites are organized by broad category headings, with little or no deep contextual value. General subject hierarchies are utilized to categorize thousands of listings under various broad subject headings. This makes pinpoint navigation of an offered item utilizing the hierarchy difficult and time intensive. Additionally, the online search functionality provided by said commerce sites generally extends only to the seller provided item descriptions and titles. The ability of sellers to accurately and completely describe their goods, as well as properly classify them in a site provided hierarchy, varies greatly, which in turn impacts the ability of prospective buyers to locate specific item listings. Additionally, this ad hoc approach makes it difficult for buyers to locate and view listings of closely related collectible items in a single search query.

Moreover, useful archival information associated with each online sale is lost, as it fails to be archived in any meaningful context. The lack of an organized collectibles taxonomy having unique classification means and descriptive item information, often creates confusion and frustration in the marketplace. This is evidenced by the multiple e-mail communications between prospective buyers and sellers necessitated due to lack of detail in a seller's listing, a lack of understanding of the particular good on the buyer's part, and failings of included illustrations and statements regarding item condition.

Additionally, most commerce sites do not include convenient alternatives (e.g. classified listings or barter listings) to the common auction method of performing transactions, which for many users, may be more useful and desirable in certain circumstances.

Accordingly, there remains the need for an online marketplace which provides complete, meaningful collectibles information, transactional flexibility and communication, all coupled with detailed real time marketplace and appraisal information.

### SUMMARY OF THE INVENTION

The present invention relates to an online database service (hereinafter “market site”), which provides a marketplace for completing online transactions. The market site comprises a collectibles hierarchy consisting of collectibles subject matter derived from a plurality of collector's guide books, used good publications, collectibles source information such as manufacturer's product listings, or collectibles databases (hereinafter collectively referred to as “cGuides”). The cGuides provide information related to the various categories of collectibles, and contain therein, a plurality of subject matter hierarchical branches. The lowest branch of each of the hierarchical branches ultimately terminates into a plurality of collectible item leaf nodes. The collectible item leaf nodes contain therein a plurality of descriptive collectibles data, including searchable data fields, which, by way of example, include data such as manufacture, model, pricing information, etc. derived from a plurality of said cGuides sources. User entered auction, barter and classified listings are received and associated (selectively catalogued) with each of the respective collectible item leaf nodes. An identification system (eg. alpha-numeric numbering system or other identification system) for uniquely identifying and labeling hierarchical branches, collectible item leaf nodes and related user entered listings within the market site, is incorporated.

Associated with the collectibles hierarchy and collectible item leaf nodes is an electronic appraisal warehouse (hereinafter “eAppraisal”), comprised of data related to a plurality of archived sales, barters, and auctions, including associated graphical and media representations, and further related information such as selling price, condition/grade as described, year, number of bids received, date sold, etc., organized and classified according to the hierarchy branches, collectible item leaf nodes, and further sortable and displayable by selectable data attributes, such as sales price, condition, etc.

A transaction manager, comprising an auction manager, a classifieds manager, and a barter manager are associated with the collectibles hierarchy, collectible item leaf nodes, and user entered listings. Included are management devices typical of the prior art, including both supply side management mechanisms (for processing offers to auction/sell/barter) and demand side mechanisms (for processing bids/purchases/barters).

A search engine, having the ability to search the hierarchy, collectible item leaf nodes, associated collectibles data, related multimedia components, user authored auction/classified I barter listings, and market related information (all by selectable data field or full text) is offered. The search engine includes a plurality of forms available by hierarchical category which provide the means to construct searches for the various fields of data attributed to the plurality of collectible item leaf nodes. The search engine also has the ability to sort search results via various data fields, item descriptions or market related data/events.

A user customized page, having the capability to track a user's auctions, classifieds (fixed price items), or barter exchanges, (regardless if seller/buyer), including prospective bids, and hierarchical category/item monitoring is offered. Where elected by the user, an additional/alternate tracking e-mail notification system, having similar capabilities is included, which manifest the ability to notify a user of site related events, including price, volume, availability, etc. of items offered, prospectively offered, or solicited on the market site.

A user database manager, capable of authenticating, tracking and storing user information such as ID, name, address, rating, etc. is incorporated.

An item labeling program, capable of selectively producing labels associated with the collectibles hierarchy, collectible item leaf nodes and related user entered listings, including identification information, pricing information, descriptive product information, seller information, etc., is introduced. The labels created therefrom are scannable in form.

A collectibles identification device (CID), comprising a scanner or similar device, accompanied by a computing device (either attached, integral or severable), capable of accepting, storing or transmitting data is made available to retrieve information pertaining to said scannable label item (SKU, UPC or previously discussed market site derived label). Once scanned, database information associated with the scanned item is readily retrieved/displayed from the market site.

A shipping label program, capable of automatically generating mailing labels for shipment of sold/bartered items to the appropriate recipient is offered.

A contract generation feature, capable of generating a sales contract, receipt or invoice document, based upon user information (e.g. name and address) and market site events (successfully completed auctions, classified sales, etc) is made available. This contract is printable in form, and may include unique user selected information such as the seller's business logo, special shipping terms, etc.

### BRIEF DESCRIPTION OF THE DRAWINGS

FIG. 1 is a schematic block diagram illustrating one embodiment of the invention;

FIG. 2 is an illustration of a representative data display screen for a collectible item leaf node;

FIG. 3 is an illustration of a representative data display screen for an intermediate hierarchical branch; and

FIG. 4 is an illustration of a representative eAppraisal data display screen.

### DETAILED DESCRIPTION OF THE PREFERRED EMBODIMENTS

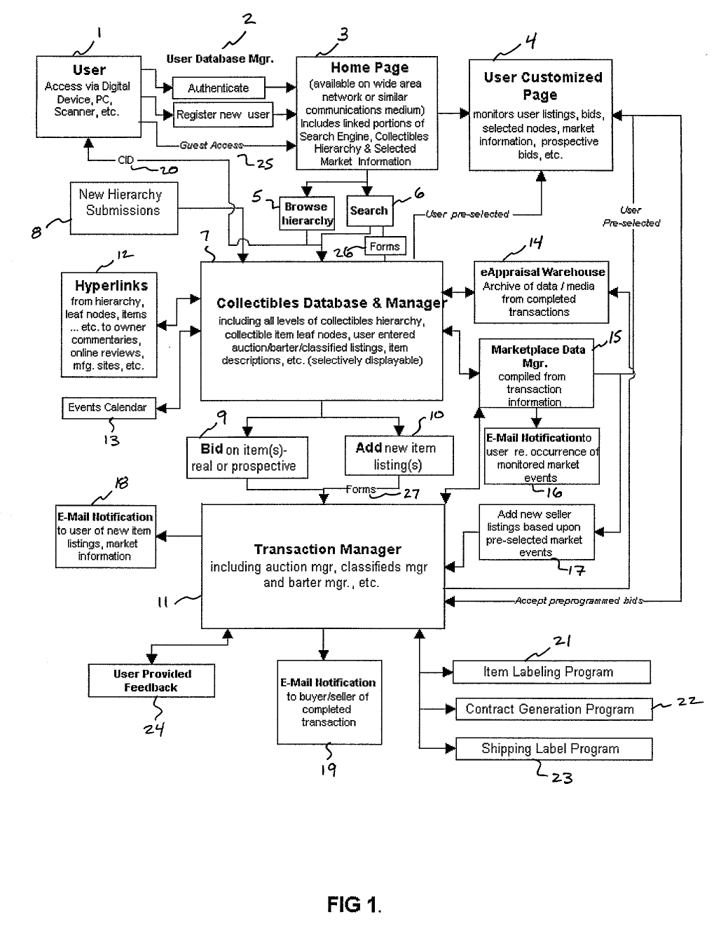

An inventive method and system is disclosed for implementing an electronic online marketplace on a central server host attached to a wide area network, preferably the Internet, accessible by a plurality of remote users. FIG. 1. shows a collectibles database and manager (CDM) 7, comprised of a collectibles hierarchy consisting of collectibles subject matter, and further arranged in a navigable hierarchical fashion. Said collectibles hierarchy is derived from data contained in a plurality of collector's guide books, used good publications, collectibles source information such as manufacturer's product listings, or collectibles databases (hereinafter collectively referred to as “cGuides”). The CDM 7 collectibles hierarchy may be augmented over time by expert authors, collectibles expert submissions, or user submissions subsequently validated by an association of market site users or predetermined expert panel. The cGuides provide information related to the various categories of collectibles, and contain therein, a plurality of subject matter hierarchical branches. The lowest branch of each of the hierarchical branches terminates into a plurality of collectible item leaf nodes. The collectible item leaf nodes contain therein descriptive collectibles data, including searchable data fields, which by way of example, may include item manufacture, model, year, pricing information, etc. derived from the cGuides. Additional user accessible information includes collectibles grading information, made available at any relevant branch or node within the collectibles hierarchy. Said collectibles grading information may include useful advice such as how to grade by particular category, how to identify fake or bogus goods, etc., and includes a reporting mechanism for identifying fake goods currently listed or formerly listed on the market site.

User 1 entered auction, barter and classified listings are received into the CDM 7 and associated with each of the respective collectible item leaf nodes via interactive data entry forms. Said listings may include user authored text information, images, and other multimedia components. Said listings are further selectively classified by variables associated with the searchable data fields, e.g. manufacture, model, price, year, condition of item, color, etc. The net effect is that all user entered listings are properly classified to an exacting degree of specificity, generally at the collectible item leaf nodes level of the collectibles hierarchy.

Accompanying the collectibles hierarchy and collectible item leaf nodes are selectable hyper-linked data 12 such as the listing of owners of like collectibles—including contact information, commentaries submitted by owner's of like collectibles, and a listing of sellers of the particular collectible. Hyperlinks to related news articles, online reviews, manufacturer's web sites, dealers, owner's groups, repair shops, and book discussions may be included.

In a further embodiment, hyperlinks to associated external gatherings or events 13, arranged in a calendar interface, by date, time, event type, and geography, are included with each collectibles hierarchical branch/collectibles item leaf node. If elected by the user, multiple hierarchical branches and node selections as related to the events might be selected and then displayed in a single events calendar, accessible from the hierarchy or a user customized page 4. In a related embodiment, a similar approach is utilized for other activities such as a dealer's sales activities and unique item related events (e.g. where the leaf node is a musical recording the calendar might indicate the tour schedule of the recording artist). Said calendar may include an e-mail notification system which notifies the user of new events posted in the calendar which meet previously selected user criterion.

Additional suggestive hyperlinks to related hierarchical categories or collectible items and descriptions may be included based upon conventional collaborative filtering techniques.

Selectable additions to the collectible item leaf nodes may include “unclassified” end nodes (e.g. for listings incapable of being readily classified under particular leaf nodes) as well as “lots” or “collections” end nodes, wherein groupings of user auction, barter, and classified listings not falling under specific hierarchical end nodes are offered under higher subject level headings.

An identification system (e.g. unique alpha-numeric numbering system, UPC, SKU, or other identification system, etc.) for uniquely identifying and labeling hierarchical branches, collectible item leaf nodes and related user entered listings within the hierarchy is incorporated. Listings 10 submitted by users are classified according to the collectibles hierarchy or collectible item leaf nodes, using interactive listing forms generated by the market site. Data fields relevant to the particular collectible item leaf nodes appear on each listing form, and enable organized user listing entries and selections such as manufacturer, model, condition, color, etc. Additional user authored descriptive text, graphics and other multimedia may be submitted along with each listing. Submitted graphical media is ideally normalized (e.g. common display dimensions and optimized file size) for visually consistent presentation on the market site. However, original graphical content is maintained for selective recall by market site users.

This above described method of classifying ensures that collectible item listings are properly classified, readily locatable, archivable and complete. Additionally, it provides a vehicle for tracking marketplace data and conditions in a marketplace data manager 15, for the specific collectible item as well as any of its associated hierarchy components. By way of example, the following calculations using conventional algorithms, are readily derivable and displayable by the marketplace data manager: the number (volume) of listings for a particular item or items (current or over time), the total number of bids (current or over time), pricing information (current or over time—high sale, low sale, median sale), associated graphical charts showing fluctuations in price, offered volume, bid volume, and number of closed sales. Associated percentages (fixed and dynamic) may also be calculated and displayed. Bids may be tabulated, the number of discreet bidders determined, price comparisons made, and growth indices calculated and displayed. Relative market conditions may be reported, for example, the fastest growing category by price increases, volume increases, etc.

Furthermore, changes in market conditions as calculated by the marketplace data manager 15 may act to selectively trigger the posting of previously entered user item listings which earlier specified that said listings be posted on the market site only when market conditions for the item reached a particular price or volume threshold 17. Additionally, certain market conditions may programmatically trigger a predetermined bid from a prospective buyer on a newly introduced auction item/classifieds item 18. Given the cataloguing of the listings, a market signaling device can be generated showing items or categories escalating in sales price, items declining in sales price, increases in volume for particular items, decreases in volume for particular items, etc. Moreover, totals, movements, percentiles, etc. in outstanding prospective bids (for currently unlisted auction items) are easily tabulated and reported. In a further embodiment, any of the above described market events could programmatically trigger an e-mail notification to a market site user, for example, the posting of a new listing under a particular hierarchy level or node, dramatic changes in price or volume in a particular collectibles category, etc.

Associated with each of the collectible item leaf nodes is an electronic appraisal warehouse (eAppraisal) 14, comprised of data related to a plurality of archived sales, barter and auctions data, including associated graphical and media representations, selling price (unless a barter), condition as described, etc., organized according to the collectible hierarchies and collectible item leaf nodes, and sortable by selectable data attributes, such as sales price, condition, color, etc. The graphical representations are ideally normalized (e.g. common display dimensions and optimized file size) for ease of browsing. However, original graphical content is maintained for selective recall by market site users. When a quantitatively significant number of eAppraisal entries have been gathered with respect to the collectible item leaf nodes, including price, grade, model variations, etc., then said eAppraisal information is programmatically consolidated and made available to the user in the form of a “virtual” collectibles price guide. Prior to that time, price information as made available by publishing pricing information derived by the cGuides. Over time, redundant, outdated, cumulative eAppraisal information will be filtered and removed for storage in an electronic data archive for historical information access.

A transaction manager 11, comprising an auction manager, a classifieds manager, and a barter manager is associated with the collectibles hierarchy, collectible item leaf nodes, and user entered listings. Included are management devices typical of the prior art, including both supply side management mechanisms (for processing offers to auction/sell/barter) and demand side mechanisms (for processing bids/purchases/barters). The transaction manager 11 facilitates the market site auction, barter, and classifieds process, functioning similarly to that of the prior art (e.g. ebay.com, ubarter.com, etc.), and furthermore, triggers various notification events based upon specific transaction occurrences, including listing of a new item 18, and completion of a transaction 19, etc. Additionally, combinations of the differing types of transaction mechanisms are enabled. For example, a user might list an item as a classified at X price for a given number of days. If after that time, the item is not sold, the transaction manager 11 might then offer the item up for auction.

Alternatively, a user may list an item for barter, if the item fails to be bartered within a given number of days, it might then go to auction or be listed as a classified. Similarly, an auction listing that receives no bids or fails to receive a bid above a stated reserve price, might consequently be listed as a classified at a predetermined user set price. Over time, said price might be variable priced, e.g. discounted over a given period of days, until the item is ultimately purchased. All of these methods allow the seller great flexibility in expediting their online transactions.

A further embodiment pertaining to the barter manager comprises the cataloguing and classifying of items wanted by the user along with items the user is willing to exchange under the CDM 7 collectible hierarchies and collectible item leaf nodes. The barter manager then processes the data and pairs barterers who have matching exchange criteria. Furthermore, barter “chains” may be processed by the barter manager, to process multiple party exchanges. For example wherein “x wants y”, “y wants z”, and “z wants x”, no one pair can exchange to satisfy a barter, however, all parties can exchange and be satisfied if they exchange amongst the group. If no match is found, the barterer may elect to “float” their listing, that is, allow it to reside on the market site, for possible future matching with a new barter entry.

Users navigating the hierarchy may easily derive what is wanted as well as what is offered in light of the cataloguing of the barter listings under the CDM 7 hierarchy and nodes of the market site. Additionally, a user with an item for possible exchange may input the item description into a search, and quickly receive back from the site, what, if anything, is offered in exchange for the inputted item. Alternatively, a user seeking a specific item, could input the item description in an electronic search, and quickly receive back from the site, what, if anything, is needed to offer in exchange to receive the inputted item through a barter transaction. This model works particularly well for goods that are similar or uniform in type (e.g. audio recordings, books, etc.), as they are easily exchangeable on a 1 to 1 basis due to their common value. For small value items (e.g. CD's, VHS, DVD's, books, etc.) geographical information gathered by the site is utilized for sorting the potential barters by area, so as to facilitate “in-person” item exchanges.

An alternative embodiment pertaining to the barter manager involves the conventional application of a virtual currency to facilitate the barters, which in many circumstances, may be more convenient than the aforementioned embodiment.

A conventional search engine 6, having the ability to search separately or in combination, complete or in part, the collectibles hierarchy, the collectible item leaf nodes, user entered auction/classified/barter listings, associated collectibles data, multimedia components, and market related information (all by field or full text) is offered. The search engine includes a plurality of interactive search forms available by hierarchical category which provide the means to construct searches applied to the various fields of data attributed to the plurality of collectible item leaf nodes and related user entered listings. The search engine 6 proffers the ability to sort search results via various data fields, item descriptions or market related data/events, separate or in combination.

A user customized page 4, having the capability to programmatically track online auctions, classifieds, or barter exchanges, (be they bids, listings, or watch items) including prospective bids for as of yet unlisted items, inventory items to be listed in the future, and hierarchical category/node item monitoring of market data, new listings and selected listings, is made available. Said monitoring may further include the tracking of sales above a particular price threshold, sales below a particular price threshold, number of items sold over time, increases and decreases in price, fast growing categories, strike price tracking, pricing of the last sold item by node, the average prices of the last week, last month or last year for a particular node, charts tracking volume, price, and bid fluctuations, a “fast” movers index for collectibles showing substantial volume and price increases, and barter offerings for specific nodes.

Where appropriate, an additional/alternate e-mail notification system, having the same or similar capabilities is included, with functionality comprising the ability to notify a user of market related events, including price, volume, availability, upcoming collector's events, and new items offered, prospectively offered, or solicited.

The means for prospective bid entry, e.g. the ability to purchase an item when a particular item is offered at a predetermined price or below, is enabled. Said bid is entered as a “wanted” listing falling under the associated collectible item leaf node. The prospective bid may be hidden, or the author may allow the publication of the prospective bid to potential sellers, thus effecting the posting of an item “wanted” request. Subsequent listings meeting the “wanted” item criterion are identified and reported to the user via e-mail notification and a user customized page entry.

Users accessing the market site are identified and authenticated by a user database manager 2, capable of authenticating, tracking and storing user information. Much of this user information acts as a profile conduit to enable components of the market site's functionality, e.g. user feedback profiling, past transaction performance, collaborative filtering, etc. Additionally, user address information enables market site conveniences, such as omitting the need for users to re-enter said address information for particular market site components, e.g. address labels, contract forms, collectible's events, etc.

An item labeling program 21, capable of selectively producing labels associated with the collectibles hierarchy, collectible item leaf nodes, and user entered listings, including identification information, pricing information, seller information, descriptive product information, etc., is introduced. Price codes, including prices related to market site gathered marketplace data, may be elected for inclusion on the label (e.g. x % of current price but not below n price, or x % of the month's median price . . . etc.). Said item labeling program incorporates the means for publishing the unique identifier associated with each hierarchical branch, collectible item leaf node, and user entered listing. The labels created therefrom are scannable in form.

A collectibles identification device (CID) 20, comprising a scanner or similar device, accompanied by a computing device (either integral, attached or severable), capable of accepting, storing, or transmitting data is made available to retrieve information pertaining to a scannable label item (SKU, UPC or previously discussed market site derived label). Once scanned, similarly classified database information associated with the scanned item is retrieved/displayed from the market site. In this manner, all of the aforementioned market site related information associated with a hierarchical branch, particular collectible item leaf node or user listing, is available to the user of the CID 20.

A further embodiment includes the ability to archive collectible items scanned into an area of the user customized page 4. Scanned items might also be treated as new items to be entered as listings on the market site, items to be added to a prospective bid list, or items to monitor on the “watch” list of the user customized page. In a further embodiment, a CID 20 device signal (audio or visual) triggers the occurrence of a pre-determined price variance associated with an item (e.g. item price is x amount as compared to market).

According to another embodiment, the CID 20 device is utilized by a seller to remove (“pull”) a previously entered market site listing that has not been acted upon by a buyer. This system allows sellers the flexibility of offering items for sale in a physical environment, as well as a virtual environment, at the same time.

A shipping label program 23, capable of automatically generating mailing labels for shipment of sold/bartered items to the appropriate recipient is offered. A further embodiment proffers the ability to include postage and a possible tracking mechanism on the label.

Similarly, a contract generation program 20, capable of generating a sales contract, receipt or invoice document based upon user information and market site transaction events (successful auctions, classified sales, etc) is also presented. This contract is printable in form, and may include unique user selected information such as the seller's business logo, special shipping terms, etc.

### Data Display of Collectibles

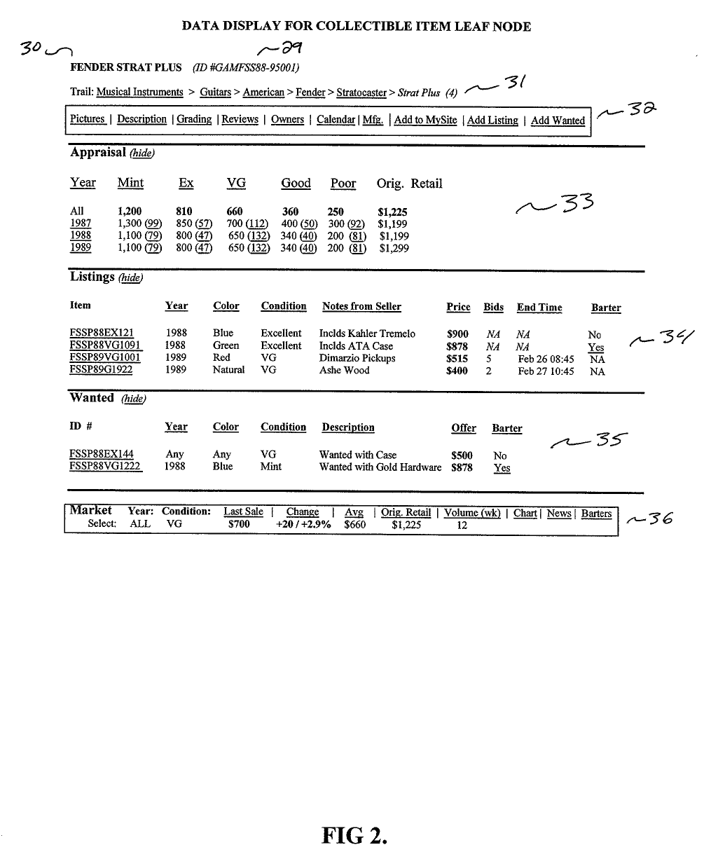

FIG. 2. illustrates an example of a data display screen for a collectible item leaf node. Contained therein is a unique identifier 29, associated with the title 30 of the collectible item leaf node. Associated with the collectible item leaf node display is a trail 31 of the collectibles hierarchy, that consists of the hierarchical path leading to the displayed collectible item leaf node. Descriptive information pertaining to the collectible item leaf node, including cGuide provided information, grading, reviews, etc., along with user selectable options such as the tracking of a collectible item leaf node via a user customized page 4, the addition of a new listing 10, proffering of a prospective bid 9, etc. are made available via hyperlinks 32.

Consolidated electronic appraisal (eAppraisal) information 33, comprised of data related to a plurality of archived sales is presented in tabular form. Said appraisal information forms the basis of a “virtual” collectibles price guide for the specific collectible item leaf node. Additionally, each of a series of grade headers identified (e.g. Mint, Ex. VG, etc.), archived sales records (parenthetically numbered links), and data field variations (here defaulted to year) provide a hyper-linked gateway into the eAppraisal warehouse, whereupon more detailed information is provided and displayable.

Associated user entered listings 34 are presented and displayed in tabular form. Said listings are sortable via links appearing on a plurality of column headings (e.g. year, color, condition, price, bids, etc), and further include item number links to more detailed information concerning any of the particular listings. Classified listings appear with a price amount positioned in a price column, and an “NA” marking appearing in both a bid and end time column. Auction listings appear with a current auction price displayed under the price column, along with related bids and end times appearing in bids and end time columns. Barter listings appear with a “Yes” hyper-link marked in a barter column. If selected, said “Yes” link navigates a prospective barterer to a listing of items the user is willing to trade in exchange for the listed item. Said barter listings may be tied to a classified listing, such that a price amount and a barter “yes” may both appear together in a single listing for items offered for sale or trade.

User entered wanted listings 35 are presented and displayed in tabular form. Said listings are sortable via links appearing on a plurality of column headings (e.g. year, color, condition, etc.), and further include ID number links to more detailed information concerning any of the particular wanted listings. A prospective bid amount appearing under an offer column will be displayed when the author of the wanted listing indicates a willingness to publish the offer, otherwise a null amount (e.g. “−”) or some other indicator such as “TBD” (to be determined) will be indicated. Additionally, if the author of the wanted listing chooses to offer a plurality of items in trade for a wanted item, a barter column associated with the listing will appear with a “Yes” hyper-link marked in said barter column. If selected, said “Yes” link navigates a prospective barterer to a listing of items the user is willing to trade in exchange for the listed item.

Collectibles market information 36 comprised of data related to a plurality of archived market site transactions associated with a user selected collectibles item is presented in tabular form. Said information is processed via the marketplace data manager 15 which outputs useful market information including “last sale” of a selected collectibles item, dollar difference and percentage change over previous sale, average sales price of the item as provided by the eAppraisal warehouse 14, original retail price (or average retail price) of the item as provided by said cGuides, volume of transactions, and additional hyper-links. Said hyper-links make available chart information for the collectible, e.g. volume of transactions over selected time periods, changes in price over selected time periods, etc., market news information related to the collectibles item, and hyper-links to barter listings for successfully completed barters that identify specifically what was traded for the collectible item.

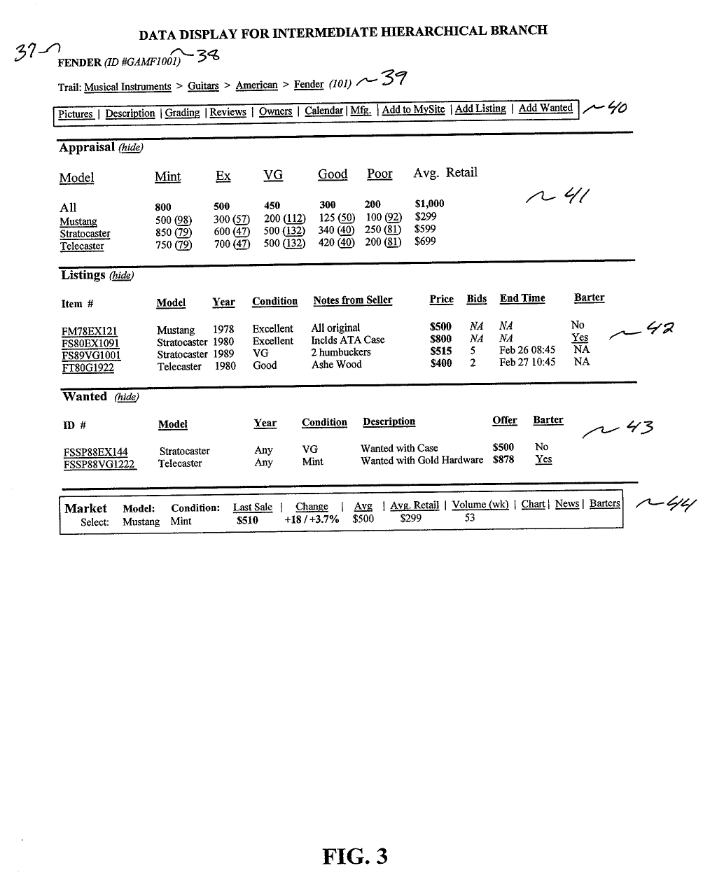

FIG. 3. illustrates an example of a data display screen for an intermediate hierarchical branch 37. Contained therein is a unique identifier 38, associated with the title 37 of the intermediate hierarchical branch. Associated with the collectible item leaf node display is a trail 39 of the collectibles hierarchy, that consists of the hierarchical path leading to the displayed intermediate hierarchical branch. Descriptive information pertaining to the intermediate hierarchical branch, including cGuide provided information, grading, reviews, etc., along with user selectable options such as the tracking of an intermediate hierarchical branch via a user customized page 4, the addition of a new listing 10, proffering of a prospective bid 9, etc. are made available via hyperlinks 40.

Consolidated electronic appraisal (eAppraisal) information 41, comprised of data related to a plurality of archived sales is presented in tabular form. Said appraisal information forms the basis of a “virtual” collectibles price guide for the specific intermediate hierarchical branch. Additionally, each of a series of grade headers identified (e.g. Mint, Ex. VG, etc.), archived sales records (parenthetically numbered links), and data field variations (here defaulted to model) provide a hyper-linked gateway into the eAppraisal warehouse 14, whereupon more detailed information is provided and displayable.

Associated user entered listings 42 are presented and displayed in tabular form. Said listings are sortable via links appearing on a plurality of column headings (e.g. model, year, condition, price, bids, etc), and further include item number links to more detailed information concerning any of the particular listings. Classified listings appear with a price amount positioned in a price column, and an “NA” marking appearing in both a bid and end time column. Auction listings appear with a current auction price displayed under the price column, along with related bids and end times appearing in bids and end time columns. Barter listings appear with a “Yes” hyper-link marked in a barter column. If selected, said “Yes” link navigates a prospective barterer to a listing of items the user is willing to trade in exchange for the listed item. Said barter listings may be tied to a classified listing, such that a price amount and a barter “yes” may both appear together in a single listing for items offered for sale or trade.

User entered wanted listings 43 are presented and displayed in tabular form. Said listings are sortable via links appearing on a plurality of column headings (e.g. model, year, condition, etc.), and further include ID number links to more detailed information concerning any of the particular wanted listings. A prospective bid amount appearing under an offer column will be displayed when the author of the wanted listing indicates a willingness to publish the offer, otherwise a null amount (e.g. “−”) or some other indicator such as “TBD” (to be determined) will be indicated. Additionally, if the author of the wanted listing chooses to offer a plurality of items in trade for a wanted item, a barter column associated with the listing will appear with a “Yes” hyper-link marked in said barter column. If selected, said “Yes” link navigates a prospective barterer to a listing of items the user is willing to trade in exchange for the listed item.

Collectibles market information 44 comprised of data related to a plurality of archived market site transactions associated with a user selected collectibles category is presented in tabular form. Said information is processed via the marketplace data manager 15 which outputs useful market information including “last sale” of a selected collectibles category, dollar difference and percentage change over previous sale, average sales price of the item as provided by the eAppraisal warehouse 14, original retail price (or average retail price) of the item as provided by said cGuides, volume of transactions, and additional hyper-links. Said hyper-links make available chart information for the collectibles category, e.g. volume of transactions over selected time periods, changes in price over selected time periods, etc., market news information related to the collectibles item, and hyper-links to barter listings for successfully completed barters that identify specifically what was traded for the collectible item.

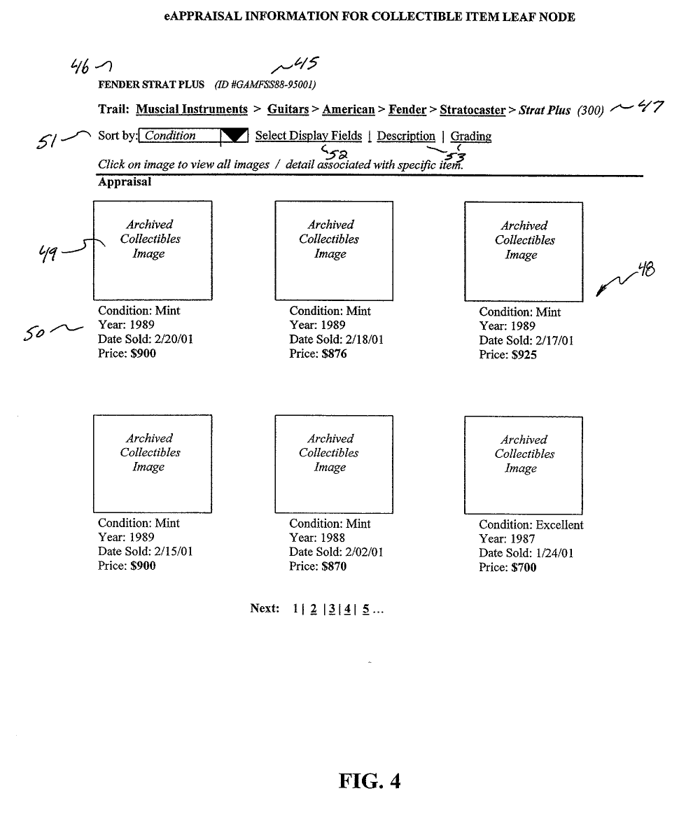

FIG. 4. illustrates an example of an eAppraisal data display screen presented and displayed at the collectible item leaf node level. Contained therein is a unique identifier 45, associated with the title 46 of the collectible item leaf node. Associated with the data display is a trail 47 of the collectibles hierarchy, that consists of the hierarchical path leading to the displayed collectible item leaf node. Archived electronic appraisal (eAppraisal) information 48, comprised of data related to a plurality of archived sales, barters, and auctions, is presented in a series of visually aligned columns and rows. Included therein are associated graphical and media representations 49, and further related information fields, such as selling price, condition/grade as described, year, date sold, etc., 50 organized and classified according to the hierarchy branches, collectible item leaf nodes, and collectible item listings. Said related information fields are selectable for display by a display fields link 52 and sortable by selectable data attributes 51, such as sales price, condition, etc. Further information such as descriptive cGuide information pertaining to the collectibles item leaf node or related grading information is available via hyper-links 53 provided to the user. By clicking on any of said graphical and media representations 49, the user is hyper-linked to all of the market site stored archived graphical and media representations of the selected item, along with a full description of the specific collectible item and its transaction parameters. This description may for public policy or individual privacy reasons, exclude sensitive information such as seller identity, buyer identity, etc.

The following will illustrate one method of using the market site. It should be appreciated that the following describes one of numerous methods of utilizing the system and in now way limits the scope of the invention.

Upon accessing and entering the market site via a remote terminal, the user is first prompted to enter an ID and Password by the user database manager 2. After the user enters their ID/Password, the user database manager 2 authenticates the entry. If the entry is not authenticated, the user is so advised. If the entry is authenticated, the user is advanced to the home page 3 of the market site. New users without an ID/Password are invited to register on the market site. If registration is elected, the user fills out an online form which solicits information such as name, address, phone, e-mail, interests, etc. and offers the ability for the user to elect an ID/Password combination. Once the form is completed, the user's ID/Password is confirmed via e-mail or other secure method, whereupon the user, so advised, may then advance to the home page 3 of the market site. An alternate embodiment would assign a password and then confirm via e-mail or other secure method. Users not interested in registering with the market site are offered “guest” access 25, and advanced to the home page 3 of the market site. “Guest” access 25 users are not permitted to engage in any market site commerce transactions.

Once at the home page 3 users may elect to browse the collectibles hierarchy of the market site (contained in the collectibles database & manager (CDM) 7), or search 6 the market site using conventional free text search syntax, or by using interactive forms 26 having searchable data fields. If browsing the collectibles hierarchy of the CDM 7 is elected, users first navigate a subject heading of interest (for example “musical instruments”) Further hierarchy branches are then selected (for example “guitars”, “american”, then “Fender”), followed by subsequent branches which navigate the user into a more granular domain of collectibles. Ultimately, the user navigates to a collectible item leaf node. (for example “Strat Plus”). Beneath the collectible item leaf nodes, the user may elect to view user entered auction, barter or classified listings. Additionally, the user may elect to see a wealth of collectors information as assimilated from said “cGuides”, descriptive information pertaining to the associated collectible, information related to the market conditions and sales trends of the collectible as provided by the marketplace data manager 15, grading information related to the collectible, etc. Hyperlinks 12 to news articles, online reviews, manufacturer's sites, events and gathering information 13, etc. are available for further navigation if the user desires more information.

The user may also elect to review online electronic appraisal and “virtual” price guide information from the electronic appraisal warehouse 14 for further information pertaining to the collectible item. The electronic appraisal warehouse 14 transmits useful archived sales and auction information of the collectible to the user including images of the collectible in various conditions, price points, age, date, etc. arranged in sequence by user selected sort fields.

The user may purchase, barter, or bid on a particular listing using conventional auction, barter and classified procedures, or alternatively add any leaf node/collectible item level to their user customized page 4 for regular updating and monitoring, including monitoring for new listings, specific market conditions as compiled by the marketplace data manager 15, etc. The user may also place a prospective bid 9 on an item not yet available (due to the absence of a listing or absence of an affordable listing) specifying the parameters of when and how the bid should be placed. The user may engage an e-mail notification 16, 18 program to notify the user of any of the foregoing updating, monitoring, and prospective bid devices.

A further embodiment allows the user the ability to toggle on the display of the auction, classified and barter listings associated with any level in the hierarchy, excluding some or all of the accompanying descriptive information, marketplace data and links. This allows for quick and convenient navigation of the listings when “what is offered for sale” is the primary concern of the user, and the more detailed information is of no immediate value to the user. The user may elect at any time while browsing or searching, which nodes and fields of data, associated with the hierarchy or items, should display.

Should the user possess a collectible item they have determined would be a candidate to offer for sale, barter, or at auction, the user may hyperlink to an online listing form 27. Said listing form 27 then assists the user with cataloguing their collectible item under the collectibles hierarchy and collectible item leaf nodes, entering descriptive information regarding the sale item into the appropriate data fields, and identifying the transaction parameters for the auction, sale or barter of the item. The form also assists the user with submitting sale item related multimedia components (e.g. graphics files) for publication on the market site. Once so entered, a monitor listing is added to the user customized page 4 for subsequent monitoring of posted listings. When and if the item is sold, the user is so notified via e-mail notification 19 and a posting appearing on the user customized page 4.

The user may print a shipping label using the shipping label program 23, which includes the address of the user (seller) and the address of the buyer obtained from the market site. In a further embodiment, the shipping label program 23, would include the ability for the user to automatically add the appropriate postage and possible tracking mechanism to the printed out shipping label.

If so desired, the user may generate an invoice, receipt or contract for the sale of the collectible item using the contract generation program 22 utilizing user and transaction data stored and obtained from the market site.

Furthermore, once a collectibles transaction conducted on the market site has been fully performed, the users involved in the transaction may provide feedback 28 to the market site using conventional means provided by the prior art. Said feedback is integrated, stored and offered via the market site as in common prior art applications.

A further embodiment would enable a user interested in selling an item (either via the market site or via conventional means), who has previously completed an online listing form, identified their sale item under the hierarchy, entered descriptive information regarding the sale item, and included possible price points, the ability to print an item label, utilizing the item labeling program 24. The item label so produced is used for uniquely identifying and labeling the item. Other users of the market site, using a collectibles identification device (CID) 20, may then subsequently scan the label of the item and readily identify and obtain descriptive item information, market conditions and appraisal information associated with the item, via communication with the market site.

It is to be understood that the embodiments and variations shown and described herein are merely illustrative of the principles of this invention and that various modifications may be implemented by those skilled in the art without departing from the scope and spirit of the invention.

What is claimed is:

1. A method for providing an online collectibles marketplace over a computer network comprising the steps of:
providing a navigable hierarchy of collectibles subject matter to a remote first user of said collectibles marketplace, said hierarchy having a plurality of hierarchical branches that terminate into a plurality of collectible item leaf nodes, said collectible item leaf nodes including descriptive collectibles data arranged and stored to facilitate remote access by employing at least one of the following steps: (a) navigating said navigable hierarchy, (b) referencing said collectible item leaf nodes, and (c) electronically searching said collectibles data;
accepting a plurality of collectibles listings from said remote first user;
classifying said collectibles listings with said navigable hierarchy of collectibles subject matter; and
publishing said classified collectibles listings on said collectibles marketplace to a remote first buyer, said collectibles listings accessible to said first remote buyer by employing at least one of the following steps: (a) navigation of the navigable hierarchy, (b) referencing said collectible item leaf nodes, and (c) electronically searching said collectibles data.

2. The method of claim 1 wherein transaction data associated with a plurality of transactions involving said collectibles listings is electronically stored and archived to facilitate subsequent access to said transactions data by reference to said classified collectibles listings.

3. A method for providing an online collectibles marketplace over a computer network comprising the steps of:
providing a navigable hierarchy of collectibles subject matter to a remote first user of said collectibles marketplace, said hierarchy having a plurality of hierarchical branches that terminate into a plurality of collectible item leaf nodes, said collectible item leaf nodes including descriptive collectibles data arranged and stored to facilitate remote access by employing at least one of the following steps: (a) navigating said navigable hierarchy, (b) referencing said collectible item leaf nodes, and (c) electronically searching said collectibles data;
associating a plurality of unique identifiers with said navigable hierarchy of collectibles subject matter;
accepting a plurality of collectibles listings from said remote first user;
classifying said collectibles listings with said navigable hierarchy of collectibles subject matter; and
publishing said classified collectibles listings on said collectibles marketplace to a remote first buyer, said collectibles listings accessible to said first remote buyer by employing at least one of the following steps: (a) navigation of the navigable hierarchy, (b) referencing said collectible item leaf nodes, and (c) electronically searching said collectibles data.

4. The method of claim 3 wherein said unique identifiers are print enabled and scannable in form such that a scanning device may accept, store or transmit information pertaining to said unique identifiers and collectibles marketplace data associated with said unique identifiers.

5. The method of claim 3 wherein transaction data associated with a plurality of transactions involving said collectibles listings is electronically stored and archived to facilitate subsequent access to said transaction data by reference to said classified collectibles listings.

6. The method of claim 3 wherein extrinsic collectibles related data, including information provided by at least one of the following: (a) collectibles publications, (b) collectibles experts, (c) collectibles reviews, and (d) collectibles events information, is arranged, stored, and made accessible on said collectibles marketplace by reference to said navigable hierarchy and said collectible item leaf nodes.

7. The method of claim 3 further comprising the step of selectively outputting data in response to said steps of accepting and classifying said collectibles listings.

8. The method of claim 3 further comprising the step of selectively outputting data in response to a plurality of transactions involving said collectibles listings.
